(19) United States
(12) Patent Application Publication
(10) Pub. No.: US 2025/0004441 A1
(43) Pub. Date: Jan. 2, 2025

(54) Method, system and devices for identifying the cause of oscillations in a control loop of a control valve in a controlled process plant

(71) Applicant: SAMSON AKTIENGESELLSCHAFT, Frankfurt am Main (DE)

(72) Inventors: Christian Fiebiger, Hofheim am Taunusb (DE); Andreas Fiebiger, Taunusstein (DE)

(21) Appl. No.: 18/754,498

(22) Filed: Jun. 26, 2024

(30) Foreign Application Priority Data
Jun. 29, 2023 (DE) 102023117268.9

(51) Int. Cl. G05B 19/406

(52) U.S. Cl. CPC G05B 19/406; G05B 2219/41025

(57) ABSTRACT

A method is proposed for identifying the cause of oscillations in a cascaded control loop of a control valve in a controlled process plant, including the following steps: Setpoint value and actual value of the control valve are determined over time. The setpoint value and actual value are checked to see whether they exhibit a continuous oscillation. If an oscillation is detected, the amplitude and period duration are determined. If only the actual value or only the setpoint value oscillates, the period duration is compared with a characteristic period duration of the control valve. If the actual value and setpoint value oscillate, the amplitudes are compared with each other and/or the period duration is compared with a characteristic period duration of the control valve. The cause of the oscillations is identified from the comparisons. With this method, the cause of oscillations in a control loop of a control valve can be narrowed down so that the effort required for troubleshooting in the plant is reduced. Production downtimes can be minimized and costs avoided.

### CROSS-REFERENCE TO RELATED APPLICATIONS

This application claims priority to German Patent Application No. 10 2023 117 268.9, filed on Jun. 29, 2023, which is hereby incorporated herein by reference in its entirety for all purposes.

### DESCRIPTION

### Field of the Invention

The invention relates to a method for identifying the cause of oscillations in a control loop of a control valve in a controlled process plant.

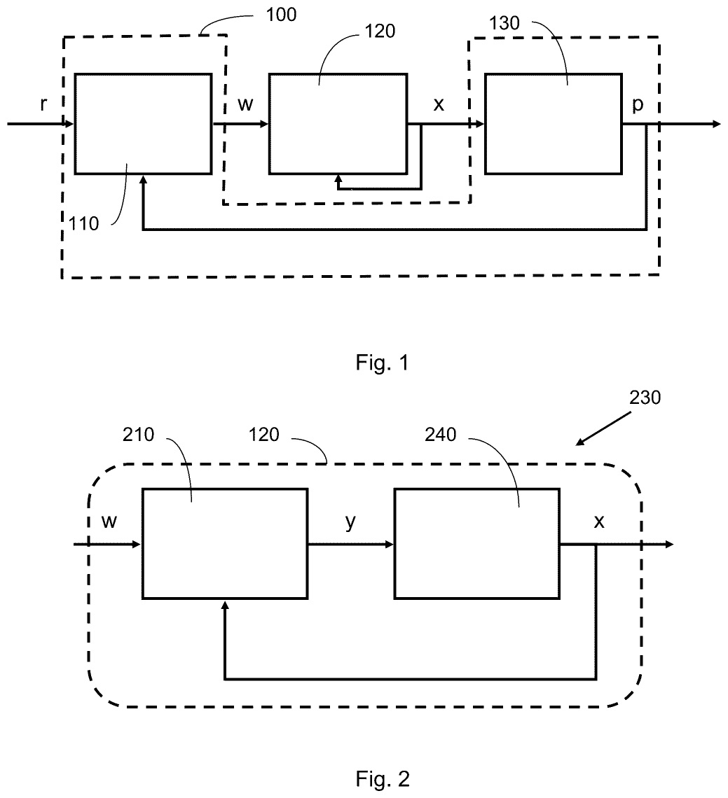

Control valves are used in technical plants to regulate a process variable, e.g. a flow rate, pressure, differential pressure, temperature, pH value, etc. For this purpose, the control valve is connected to the process and a controller assigned to the process in such a way that cascade control is achieved (see FIG. 1). The controller assigned to the process ensures that a process variable or an associated actual process value is brought closer to the setpoint value of the process. For this purpose, the controller assigned to the process calculates an output variable that serves as the setpoint value, e.g. as the position setpoint value, of a valve member of the control valve in the cascade structure. The control loop of the control valve forms the inner control loop of the cascade (see FIG. 2) and generates an actual value, e.g. for the position of the valve member, depending on the setpoint of the control valve, which in turn is an input variable for the physical process.

One of the main requirements for control loops is to ensure stable overall system behavior. For process control, this means that a process setpoint is controlled and should match the corresponding process variable with the exception of a tolerable deviation. Unwanted, unstable system behavior can be expressed, for example, by continuous oscillations of signals within the control loop. These can arise, for example, if the control signal for the control valve itself exhibits an oscillation caused by a change in one or more process variables or if the control valve introduces an oscillation, for example due to unstable position control or uneven friction.

In the event of instability in a cascaded control loop of a process plant, such continuous oscillations must be eliminated, as otherwise, for example, a product could be produced outside the specification and consequently a production batch would have to be disposed of or reprocessed. For this purpose, the maintenance personnel must search for the cause of the fault on site in the plant. The cause may lie in one of the components of the cascade, i.e. the process controller, the valve controller, the physics of the valve or its actuator or the process itself.

### Prior Art

Various evaluation methods and devices for identifying oscillations in control loops are known, but many of these are not suitable for cascade structures.

For example, a diagnostic device and a corresponding method for monitoring the operation of a control loop with a networked structure are known from the publication US 2016/0239015 A1. This diagnostic device records data series of the setpoint and actual values of the control loop. Stochastic characteristics relating to the spread of the actual and setpoint values are determined so that the control quality can be evaluated from their quotients.

The publication US 2007/0150079 A1 describes a self-test process control loop for a process plant. Here, signal data from the normal operation of the components of the process control loop are measured for diagnostic purposes, wherefrom parameters of the control loop are determined which allow conclusions to be drawn concerning the state of the process control loop.

In both cases, however, the possible causes of unstable behavior, poor control quality or oscillations are not determined.

### Problem

The purpose of the invention is to provide a method and devices which make it possible to identify or at least limit the cause of oscillations in the control loop of a control valve within a process plant which is itself controlled.

### Solution

This problem is solved by the subject matter of the independent claim. Advantageous embodiments of the subject matter of the independent claim are described in the subclaims. The wording of all claims is hereby incorporated into this description by reference.

The use of the singular is not intended to exclude the plural, which also applies in the opposite sense, unless otherwise disclosed.

In the following, individual method steps are described in more detail. In a preferred variant of the invention, the steps are performed in the order indicated. However, the steps need not necessarily be performed in the order indicated, and the method to be described may also comprise further, unmentioned steps.

To solve the problem, a method is proposed for identifying the cause of at least one oscillation in a process plant which comprises at least one inner control loop of a control valve and at least one outer control loop, having the following steps:
The setpoint value and the actual value of the inner control loop of the control valve are determined over time. This control loop regulates the position of the valve member, i.e. the setpoint and actual value relate to this position.
The setpoint value determined over time and the actual value determined over time are each checked to see whether they exhibit an oscillation, i.e. in particular a continuous oscillation.
If at least one oscillation is detected, its amplitude and/or period duration are determined. As an alternative to the period duration, the frequency can of course also be determined, as these two variables can be easily converted into each other.
If an oscillation is detected only in the actual value or only in the setpoint value, the period duration and/or the amplitude of this oscillation is compared with a predetermined characteristic variable of the control valve. Switching hysteresis may be provided for this purpose in order to avoid too rapid and/or frequent changes between states.
If an oscillation is detected in both the actual value and the setpoint value, a phase shift of the two oscillations relative to each other is determined and/or the respective amplitudes are compared with each other and/or at least one of the period durations is compared with a predetermined characteristic variable of the control valve.
A possible cause of the oscillation is identified from the comparisons made and/or the phase shift.

Preferably, the identified possible cause of the oscillation is output, e.g. as a diagnosis and/or message. The output can occur directly at the control valve or, for example, via an interface at the control system of the process plant or another monitoring system. The identified possible cause of the at least one oscillation may also be stored on a data storage medium. This makes it possible to use the knowledge gained at a later time, e.g. as part of a scheduled maintenance of the plant or the control valve.

With this method, the cause of oscillations in a control loop of a control valve can be identified or at least localized, so that the effort required for any troubleshooting by maintenance personnel on site in the plant can be kept to a minimum, as the cause of the problem can be sought specifically in the right place. If possible, the method recognizes whether an instability or oscillation originates from the process control or from the valve control. In this way, production downtimes can be minimized and unnecessary costs avoided.

The oscillation to be detected by the method preferably goes beyond individual oscillation processes in the signals. Preferably, the oscillation to be detected is essentially stable or recurring, in particular over a period of occurrence of the oscillation, and in particular does not decay. Preferably, a number of oscillation processes of the oscillation to be detected is greater than 20, preferably greater than 30 and particularly preferably greater than 40. In particular, the oscillation to be detected is formed as an instability in a signal of the control loop(s). Preferably, the oscillation to be detected is a continuous oscillation. It is conceivable that the oscillation to be detected is composed of a plurality of oscillations, wherein in particular multiple causes for the oscillations may be present.

Preferably, the identified possible cause of the at least one oscillation is assigned to the inner control loop or the outer control loop. This makes it advantageously easy to diagnose and/or eliminate the cause.

In addition to the setpoint value and the actual value of the control loop of the control valve, only variables detectable at the control valve and preferably no other variables are measured and/or used to identify the cause of the at least one oscillation. Variables detectable at the control valve are typically actuator pressure and supply air pressure (in the case of a control valve with pneumatic actuator), structure-borne noise at the valve, the control signal (air pressure or current) and a time stamp for each. This allows the method to run without problems on the positioner of the control valve, for example, without the need for additional connections or suitably configuring any other device. Furthermore, no additional sensors or similar are required.

Incorrect or uncertain diagnoses can be avoided if it is determined whether the setpoint value and the actual value of the control loop of the control valve exhibit noise and if further steps are only performed if the noise is below a predetermined threshold. This prevents, for example, incorrect oscillation characteristics being determined due to noisy signals. Noise detection is therefore preferably carried out immediately before checking whether a continuous oscillation is present.

Simplified operation and lower maintenance costs can be achieved if the method additionally provides that the identified possible cause of the at least one oscillation is automatically eliminated by adjusting parameters in the valve position control. If, for example, it is determined that the gain parameter kₚ of the proportional component of the position control of the control valve is too high, it could be reduced automatically, wherein it is observed whether the continuous oscillation subsides. The same is conceivable for the amplification parameter kᵢ of the integral component of the position control. Once the continuous oscillation has subsided, the problem would be solved and maintenance by a technician, for example, would no longer be required.

The method can be performed with particularly low computing power and memory requirements if local extreme values of the setpoint value and/or actual value determined over time are counted and/or evaluated during a predetermined time interval in order to check whether the setpoint value and/or actual value exhibit an oscillation. Determining local extreme values ultimately requires only low computing capacities. For example, a period duration can be inferred from the distances between successive alternating local maxima and minima, while the amplitude can be obtained from the difference between two successive local maxima and minima. Whether a continuous oscillation is present can be recognized, for example, by whether the determined amplitude is constant from one predetermined time interval to the next within a predetermined tolerance or at least does not decrease.

Preferably, a diagnosis and/or maintenance of the control valve is requested if an oscillation is only detected in the setpoint value. This is because the fact that the actual value does not follow an oscillation of the setpoint value could be due to a defect or maintenance requirement on the valve or its actuator. If the control valve has a positioner with an on-board diagnostic function, this may be used for this purpose and, for example, triggered automatically. The results of diagnostics and/or maintenance, if available, can be used to improve the identification of the cause of at least one oscillation. The identified cause of oscillation can be compared with a diagnostic status of the valve if such a diagnostic status is available.

In a preferred embodiment of the method, a characteristic period duration or frequency of the control valve serves as a predetermined characteristic variable. A possible cause of the at least one oscillation is identified as a setting of the control of the control valve that is unfavorable for operation of the plant if an oscillation is only detected in the actual value and/or if the amplitude of the oscillation of the actual value is greater than the amplitude of the oscillation of the setpoint value and/or if the period duration or frequency of the at least one oscillation corresponds to the characteristic period duration or frequency of the control valve. As an alternative to the period duration, the frequency of the oscillation can of course also be considered. The characteristic period duration is preferably determined from the running time of the valve member during complete opening or closing, i.e. from the time that the control valve requires for completely opening and closing. This individual characteristic of the respective valve is typically determined or ascertained when setting up or commissioning the valve. The characteristic period duration therefore describes an oscillation that occurs at the maximum possible speed at which the valve member can be moved. This is typically significantly higher than the speed of oscillations caused, for example, by faulty process control.

If the control of the control valve has a proportional component (P component) and/or an integrating component (I component), a more accurate diagnosis can be achieved in the following way: It must be taken into account that the control of the control valve may also have other components, e.g. a differential component. So-called PID controllers are often used, which have all the control components mentioned. All possible combinations of these control components are possible here. If, as already described, an unfavourable setting of the control of the control valve has been identified as a possible cause of the at least one oscillation, a parameter of the proportional component of the control of the control valve that is unfavourable for the operation of the control valve is identified as a possible specified cause of the oscillations if the period duration of the oscillation is shorter than the predetermined characteristic period duration and/or the frequency of the oscillation is greater than the predetermined characteristic frequency and/or the phase shift between the oscillations of the actual and setpoint value is below a predetermined threshold. A parameter of the integrating part of the control of the control valve that is unfavourable for the operation of the control valve is identified as a possible specified cause of the oscillations if the period duration of the oscillation is greater than the predetermined characteristic period duration and/or the frequency of the oscillation is less than the predetermined characteristic frequency and/or the phase shift between the oscillations of the actual and setpoint value is above the predetermined threshold. Greater or smaller here and in the following always means taking into account a tolerance factor, i.e. in each case one of the variables to be compared is multiplied by a specified factor which ensures that the respective comparison is fulfilled by a sufficient distance.

In a preferred embodiment of the method, a characteristic period duration or frequency of the control valve serves as a predetermined characteristic variable, as already explained above. A problem with the control of the process plant is identified as a possible cause of the oscillation if an oscillation is only detected in the setpoint value and/or if the amplitude of the oscillation of the setpoint value is greater than the amplitude of the oscillation of the actual value and/or if the period duration of the oscillation of the setpoint value is greater than the characteristic period duration of the control valve or if the frequency of the oscillation of the setpoint value is less than the characteristic frequency of the control valve.

A width of a hysteresis of the control valve, in particular of the actuator, the control and/or the valve member of the control valve, can also serve as a predetermined characteristic variable. This hysteresis is particularly pronounced in pneumatic actuators. Preferably, if an oscillation is only detected in the setpoint value, the amplitude of the oscillation is compared with the predetermined characteristic value, wherein a diagnosis and/or maintenance of the control valve is only requested if the amplitude of the oscillation exceeds the width of the combined hysteresis. This makes it possible to take into account the fact that the actual value may not follow the oscillation of the setpoint value because the amplitude is too small, so that the valve actuator cannot perform the corresponding movements. In this case, there is no indication of a fault and/or a defect in the valve, so that diagnosis and/or maintenance would be unnecessary.

Another possible cause of oscillations can be identified if an acceleration and/or structure-borne sound sensor is provided. This detects or measures shocks and vibrations in the plant. Signals from the acceleration and/or structure-borne sound sensor are checked for oscillations in the manner previously described. If an oscillation is detected, the period duration and/or frequency thereof is determined. If an oscillation is detected in the actual value and in a signal of the acceleration and/or structure-borne sound sensor, but not in the setpoint value, the period durations and/or frequencies of these oscillations are compared with each other. A vibration in the plant is identified as a possible cause of the at least one oscillation if the period durations and/or frequencies of these vibrations in the actual value and in a signal of the acceleration and/or structure-borne sound sensor are identical within a predetermined tolerance.

Yet another possible cause of oscillation can be identified if an actual value of the process is provided. This is checked in the manner already described to see whether it exhibits an oscillation, wherein, if an oscillation is detected, its period duration and/or frequency is determined. If an oscillation is detected in the actual value and in the actual value of the process, but not in the setpoint value, the period durations and/or frequencies of these oscillations are compared with each other. A pulsating fluid flow in the plant is identified as a possible cause of the at least one oscillation if the period durations and/or frequencies of these oscillations of the actual value and of the actual value of the process are identical within a predetermined tolerance.

Desired oscillations that do not require maintenance measures can be identified if a setpoint value of the process is also provided. This is checked to see whether it exhibits an oscillation. If an oscillation is detected, its period duration and/or frequency is determined. If an oscillation is detected in the actual value as well as in the setpoint value and in the setpoint value of the process, the period durations and/or frequencies of these oscillations are compared with one another. The at least one oscillation is identified as desired if the period durations and/or frequencies of these oscillations of the actual value, of the setpoint value and of the setpoint value of the process are identical within a predetermined tolerance.

The problem is also solved by a positioner for a control valve, the positioner comprising a computing unit and means which are suitable and configured for performing the steps of the method as described above. These means comprise, for example, a position sensor for measuring the actual position of the valve member. The computing unit can refer to, for example, control electronics, a digital signal processor (DSP), a microcontroller, a computer or a plurality thereof in a network with corresponding programming. The programming can, for example, be implemented as part of a fixed circuit arrangement of the control electronics, the DSP and/or the microcontroller or with the aid of field-programmable gate arrays (FPGA).

The problem is also solved by a diagnostic box for use with a control valve, wherein the diagnostic box, just like the positioner just described, comprises a computing unit with means which are suitable and configured for performing the steps of the method as described above. Such a diagnostic box can be used directly by maintenance technicians for troubleshooting in the process plant, possibly even at control valves that only have a positioner that does not adequately fulfill the requirements described above. Such a diagnostic box could also be retrofittable.

The problem is also solved by a control valve with a positioner as described above.

Furthermore, the problem is solved by a computer program comprising instructions which cause the above-described positioner and/or the above-described diagnostic box to perform the method steps according to a method as described previously.

A computer-readable medium on which the computer program just described is stored also solves the problem.

Further details and features can be found in the following description of preferred embodiments in conjunction with the figures. The respective features may be realized individually or in combination with one another. The possibilities for solving the problem are not limited to the embodiment examples. For example, range specifications always include all—unmentioned—intermediate values and all conceivable partial intervals.

The embodiment examples are shown schematically in the figures. Identical reference symbols in the individual figures denote identical or functionally identical elements or elements that correspond to each other in terms of their functions. In detail:

FIG. 1 shows a schematic representation of a cascade including a process control loop and control valve;

FIG. 2 shows a schematic representation of the control circuit of the control valve from FIG. 1;

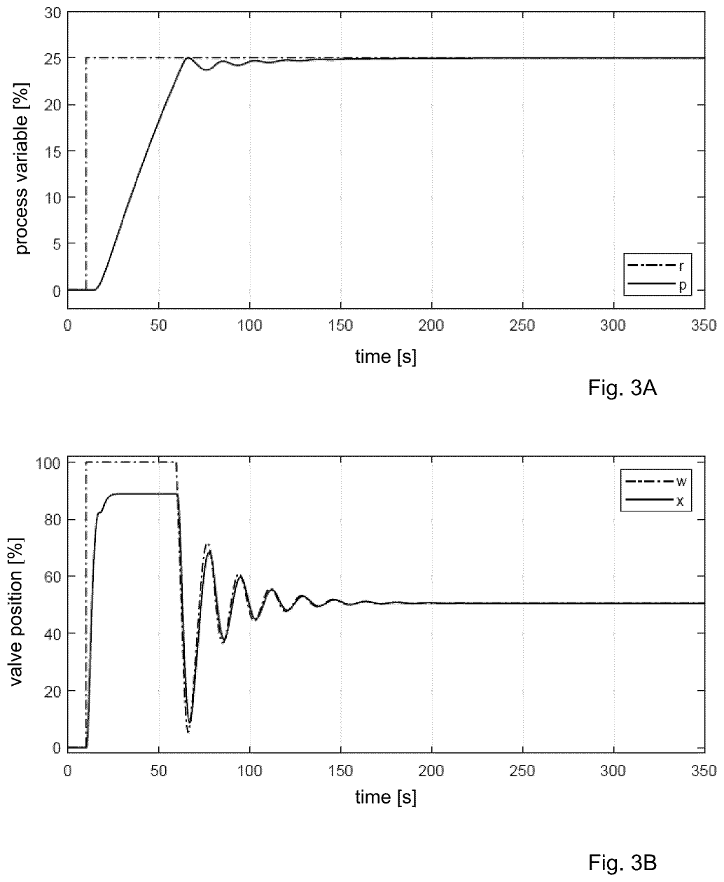

FIG. 3A shows a diagram of the time course of actual and setpoint value of the outer control loop for a simulated example in which no continuous oscillations occur;

FIG. 3B shows a diagram of the time course of actual and setpoint value of the inner control loop for a simulated example in which no continuous oscillations occur;

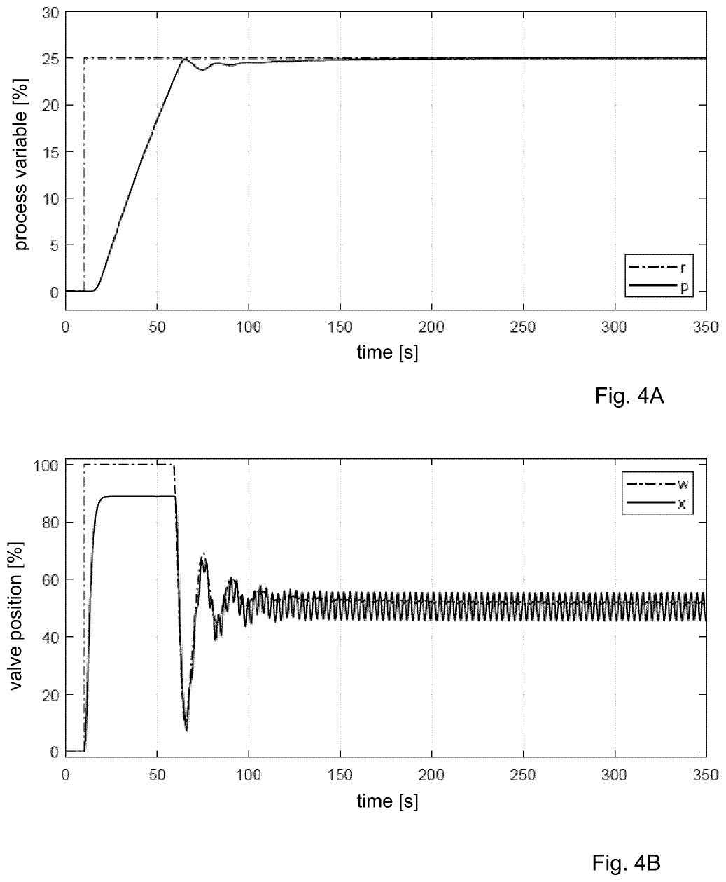

FIG. 4A shows a diagram of the time course of actual and setpoint value of the outer control loop for a simulated example in which the valve control causes a continuous oscillation;

FIG. 4B shows a diagram of the time course of actual and setpoint value of the inner control loop for a simulated example in which the valve control causes a continuous oscillation;

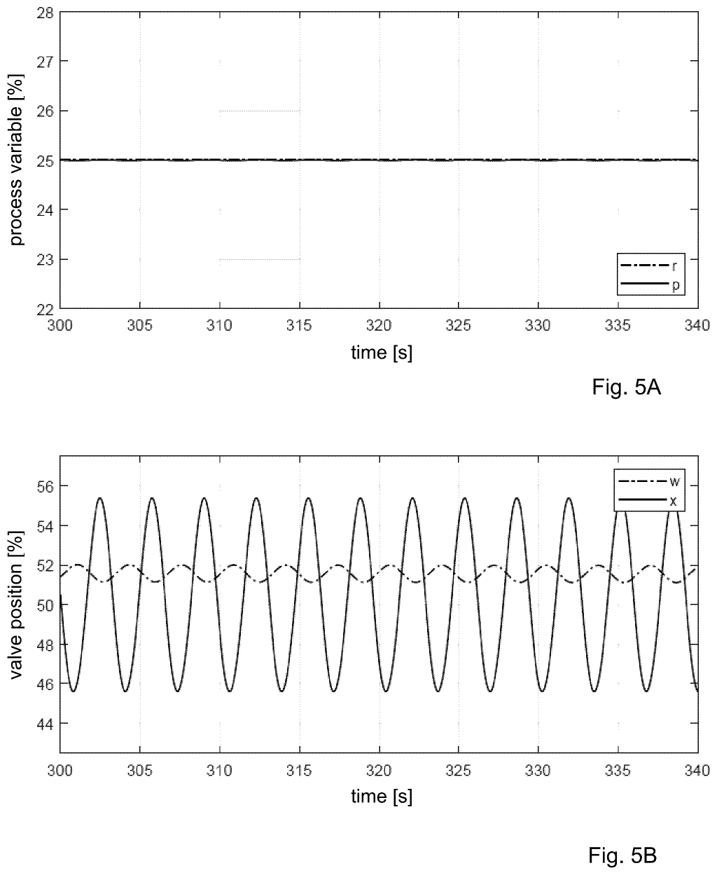

FIG. 5A shows an enlarged section of the diagram from FIG. 4A;

FIG. 5B shows an enlarged section of the diagram from FIG. 4B;

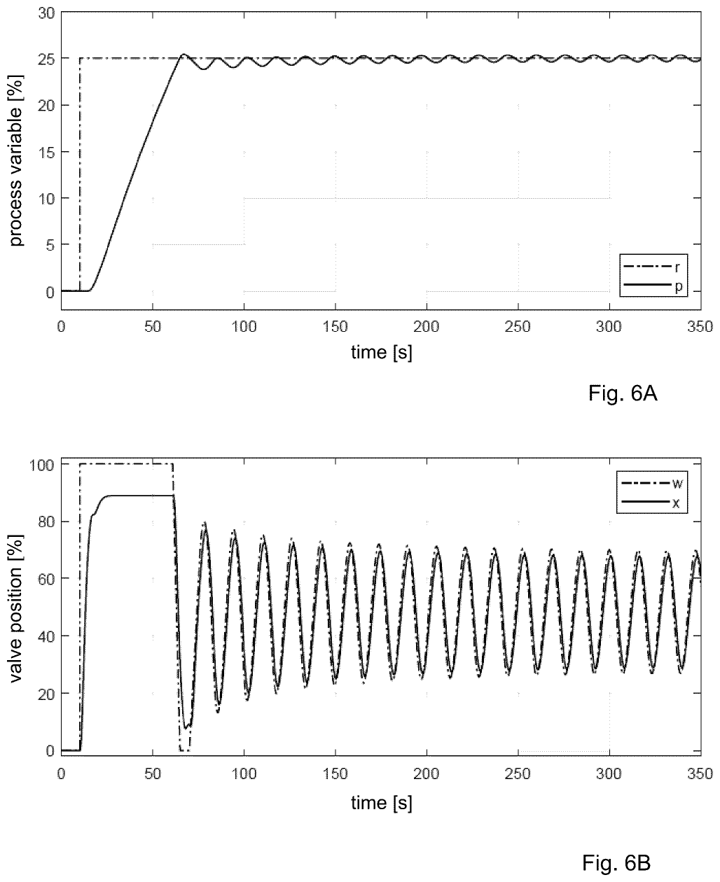

FIG. 6A shows a diagram of the time course of actual and setpoint value of the outer control loop for a simulated example in which the process control causes a continuous oscillation;

FIG. 6B shows a diagram of the time course of actual and setpoint value of the inner control loop for a simulated example in which the process control causes a continuous oscillation;

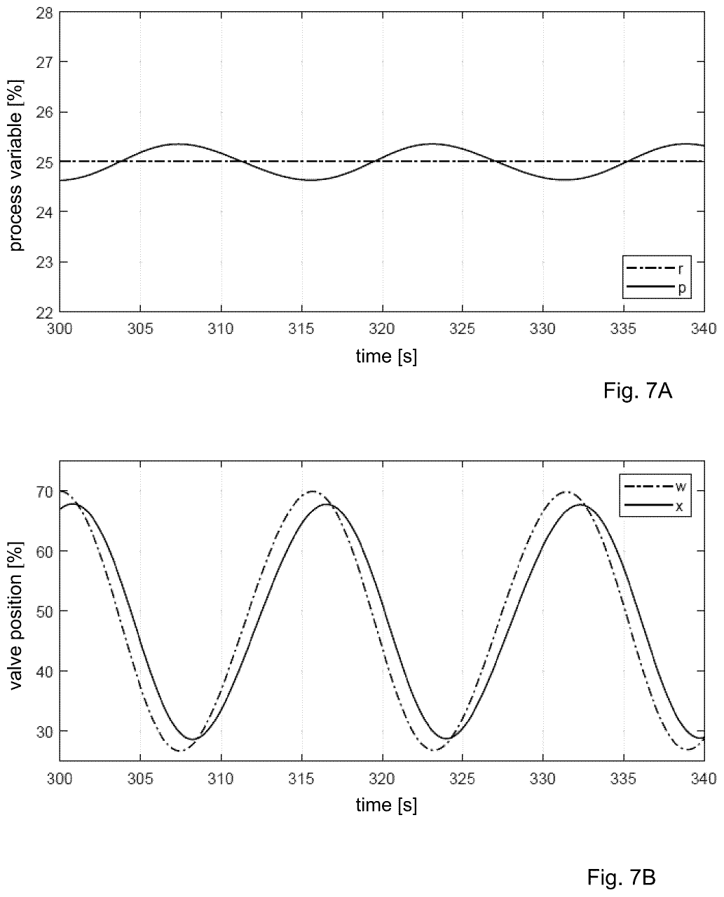

FIG. 7A shows an enlarged section of the diagram from FIG. 6A;

FIG. 7B shows an enlarged section of the diagram from FIG. 6B;

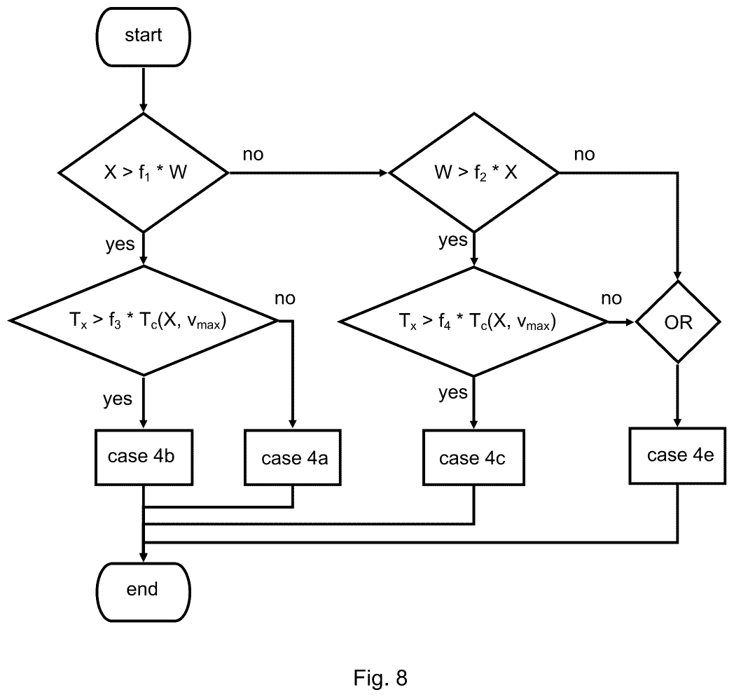

FIG. 8 shows a flow chart for a possible case differentiation if the actual and setpoint values of the valve position control both oscillate; and

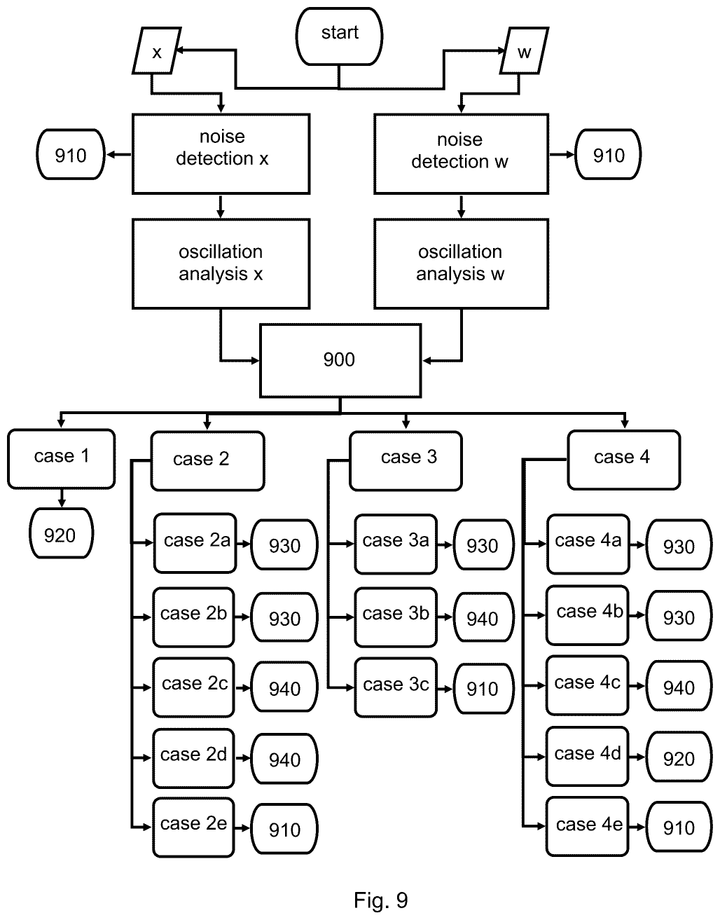

FIG. 9 shows an overview of the entire method.

FIG. 1 shows a schematic diagram of the circuitry of a process control loop, which forms the outer control loop 100 of a cascade, with a process controller 110, which is given a setpoint value r for a process parameter to be controlled. The process controller 110 generates a setpoint value w for the position of the control valve as a manipulated variable, which is controlled in the inner control loop 120 of the cascade. The actual value x of the position of the control valve influences the process 130 as a result of this cascaded control. The process parameter to be controlled changes as a result of what is measured and what is made available to the process controller 110 as the actual value p. The elements that are assigned to the outer control loop 100 of the cascade are highlighted by the dashed outline.

The associated inner control loop 120, which is formed by the position control of the control valve 230, is shown in FIG. 2 by the dashed outline. The setpoint value w for the position of the control valve specified by the process controller 110 serves as the input variable for the valve position controller 210. The valve position controller 210 uses this to generate a manipulated variable y, which influences the actuator 240 of the control valve 230, typically an electrical current or voltage or an air pressure, depending on the type of valve actuator 240 present. The position of the valve member of the control valve 230 changes accordingly, which is made available to the valve position controller 210 as the actual value x.

The positioner of a control valve within such a process control system normally only has setpoint value w and actual value x of the position of the valve element available. In addition, a diagnostic function may be available that can analyze the current status of the control valve and store the results of such a diagnosis in a log, e.g. possible causes of errors. Certain characteristic variables of the control valve may also be available, e.g. the valve transit time, which indicates how long the valve typically takes to open or close. Further data, e.g. setpoint value r and actual value p of the process control, are generally not available to the positioner of the control valve. In order to nevertheless be able to determine the cause of an instability or continuous oscillation in a cascade control system, the following steps may be provided:
Evaluate signal noise—The signal noise of the setpoint value w and actual value x of the valve element position is determined. If the analyzed signals are too noisy, no further analysis should be carried out, as the oscillation characteristics in particular could not be determined without errors. Preferably, a message is output and/or saved instead, indicating that the method cannot be performed due to excessive signal noise.
Perform oscillation analysis—Recognize whether there are oscillations of actual value x and setpoint value w of the valve position and determine the characteristic variables of the oscillations, i.e. preferably amplitude and period duration, if necessary also phase shift of the oscillations relative to one another.
Case differentiation of the identified system behavior:
   Case 1: No continuous oscillations detected—no action required.
   Case 2: Only continuous oscillation of the actual value x—the cause is probably to be found in the valve control, therefore the characteristic oscillation variables are compared with characteristic variables of the control valve.
   Case 3: Only continuous oscillation of the setpoint value w—the cause of the oscillation is probably to be found in the process control. As no oscillation of the actual value occurs, the valve does not follow the oscillation, so there could be a blockage or similar at the valve. The diagnostic function may therefore be called up or a check of the valve requested.
   Case 4: Continuous oscillations of both the setpoint value w and the actual value x—a more detailed investigation is required here, which is why the characteristic oscillation variables of the setpoint value and actual value are compared with each other and, if necessary, with characteristic variables of the control valve.
Generation of a diagnostic message for the identified case, which is output and/or saved if necessary.

The oscillation analysis may be performed using Fourier analysis, for example. However, a procedure is preferred that requires considerably less computing power and memory. With the help of the evaluation of the number and/or distances of local extreme values of the time series of setpoint value w and actual value x in a predetermined time interval Δt, for example, a flag, i.e. a Boolean parameter, is set which indicates whether the present signal has a continuous oscillation or not. Whether the continuous oscillation is still present in the next time interval Δt is determined by whether the amplitude of the signal recognized as oscillating remains approximately the same. This must also be checked. In the case of a continuous oscillation, the amplitude and period of the identified oscillation are determined. If a continuous oscillation is detected for both the setpoint value w and the actual value x, the phase shift between the two oscillations can also be determined if necessary.

In case differentiation, the most complex situation occurs when both the setpoint value w and the actual value x of the valve position exhibit continuous oscillations. In this case, an examination of the amplitudes of the two oscillations can provide information about their possible cause.

The fact that both the control loop of the control valve and the process control as a whole exhibit a low-pass characteristic can be utilized, i.e. the amplitude of an oscillation of the actual value of the respective control loop is attenuated at higher frequencies compared to the amplitude of the setpoint value.

Two cases may be distinguished in this way:
If the control valve couples the continuous oscillation into the overall control loop, the oscillation amplitude of the actual value x is damped by the strong low-pass behavior of the process control at frequencies near and above the limit frequency and is consequently coupled back to the setpoint value w with a lower amplitude.
If the process controller causes the continuous oscillation and couples it into the valve position control, the resulting oscillation amplitude of the setpoint value w may be damped by the low-pass behavior of the valve position control and in such a case the amplitude of the oscillation of the actual value x is lower. However, it is also possible that the frequency of the continuous oscillation in the process control loop is sufficiently below the cut-off frequency of the low-pass characteristic of the valve position control and the actual value x can follow the setpoint value w. In such a case, both would have the same amplitude.

FIGS. 3A to 7B show examples of simulations of the behavior of the actual values and setpoint values of the process control loop and of the position control loop of the control valve for various cases. This illustrates how the behavior of the actual value x and setpoint value w of the valve position can be used to draw conclusions about the overall oscillation situation.

FIGS. 3A and 3B show the desired situation in which neither the process control loop nor the position control loop of the control valve exhibit a continuous oscillation. In this example, the setpoint value r of a process variable changes from 0% to 25%. In FIG. 3A, this curve is shown by the dotted line. The step response of the actual value p of this process variable is shown by the solid line. It can be seen that the actual value approaches the setpoint value and that an initially present oscillation is strongly damped as it approaches the setpoint value. There is no continuous oscillation.

FIG. 3B shows the corresponding curve of setpoint value w (dotted line) and actual value x (solid line) of the valve position. The valve position at which the process variable reaches the desired value of 25% is 50% in this example, i.e. the flow is half open. The entire cascade of external and internal control loops is stable.

FIG. 4A and FIG. 4B show the same basic situation, i.e. the setpoint value r of the process variable jumps from 0% to 25%. However, in this case the cascade of the outer and inner control loop is unstable because the valve positioner causes a continuous oscillation, e.g. due to excessive amplification of its proportional component (P component). The illustration otherwise corresponds to the illustration in FIGS. 3A and 3B.

An enlarged section of the range from 300 to 340 s from FIG. 4A and 4B is shown in FIG. 5A and 5B. In this range, any transient processes have already subsided so that only the continuous oscillations can be seen. It can be seen from the comparison of FIG. 5A and 5B that the control valve, i.e. the inner control loop, oscillates, not the process control, i.e. the outer control loop. FIG. 5B also shows that the actual value x oscillates with a greater amplitude than the setpoint value w. According to the above explanations, the cause of this oscillation therefore lies in the control valve or in the position control of the valve element. The process, i.e. the external control loop, remains almost unaffected by the oscillations in this example, as can be seen in FIG. 5A.

In FIG. 6A, the setpoint value r of the process variable also jumps from 0% to 25%. The illustration in FIGS. 6A and 6B again corresponds to the illustration in FIGS. 3A and 3B. As can be seen in FIG. 6A and FIG. 6B, the cascade of outer and inner control loop is unstable in this case. Since setpoint value w and actual value x follow the specifications of the process controller with approximately the same amplitude, the causes of the continuous oscillation are presumably in the process controller. This could, for example, have too high an amplification of its proportional component of the control.

FIGS. 7A and 7B again show an enlarged section of the range from 300 to 340 s in FIGS. 6A and 6B. At this higher resolution, it can be clearly seen that in this case the amplitude of the oscillation of the setpoint value w of the valve position is greater than the amplitude of the oscillation of the actual value x. This also indicates that the causes of the continuous oscillation lie in the process control loop.

Comparing FIG. 5B with FIG. 7B, it can be seen that the period duration of the observed oscillations can alternatively be used as a distinguishing criterion. The oscillations shown in FIG. 5B, which are caused by the—comparatively fast—control of the control valve, have a period duration of approx. 3 s in this example, while the oscillations shown in FIG. 7B, which were caused by the—comparatively slow—process control, have a period duration of approx. 15.5 s. If the corresponding characteristic properties of the control loops are known, it is easy to define limits that can be used to clearly distinguish between these cases.

FIG. 8 shows in the form of a flow chart, how various possible cases in which both the actual value x and the setpoint value w of the position control of the control valve exhibit a continuous oscillation (also referred to above and in the following as case 4) can be distinguished from one another.

The amplitudes of the variables x and w are labeled with capital letters X and W. They have the same units as the variables x and w, i.e. in typical applications they are given in %.

A possible check as to whether this is a desired continuous oscillation (case 4d) would be connected upstream of the sequence shown in FIG. 8.

First, FIG. 8 checks whether the amplitude X of the actual value x of the valve position is greater than the amplitude W of the setpoint value w.

Preferably, all such comparisons are carried out using a factor f (f₁, f₂, f₃, f₄) that defines a suitable tolerance threshold. This ensures that these comparisons are robust and always provide a clear result. Alternatively or in addition to this, switching hysteresis could be provided in order to avoid switching between states too quickly and/or frequently. If necessary, these could also be used to specify the size of the tolerance factors.

If the amplitude X is now greater than f₁*W, it can be assumed that the cause of the continuous oscillations lies in the position control of the control valve. In order to be able to specify the cause of the oscillation even more precisely, it is now further investigated whether the period duration Tₓ of the oscillation of the actual value x of the valve position is significantly greater than a characteristic period duration T_{c} assigned to the control valve (T_{c} is dependent on X and vₘₐₓ, which is explained below). If this is not the case—i.e. if the control valve oscillates at approximately the maximum possible speed-it can be assumed that the oscillation is caused by an incorrect parameter in the proportional component of the position control. Typically, the gain parameter kₚ was selected too large (case 4a). This assignment of the error is due to the fact that the proportional component of a control system always acts directly, without a time delay.

If the period duration Tₓ of the oscillation of the actual value x of the valve position is actually significantly greater than the characteristic period duration T_{c} of the control valve, it is assumed that the cause of the oscillation lies in an incorrect parameter of the integrating part of the position control (case 4b). This is due to the fact that an integrating controller adds up the control deviation, i.e. a storage variable is increased or reduced. This behavior has a time-delayed effect compared to a proportional controller. Furthermore, the amplification factor of the integrating part of a control is usually smaller than that of the proportional part, which also results in comparatively slower behavior. If case 4b is identified, the cause of the error is often a dead band that is too small or a gain parameter kᵢ of the integrating component of the position control that is too large.

Alternatively, the phase shift between the oscillations of the setpoint value and actual value can also be considered here, as the different behavior of proportional and integrating controllers ensures that a smaller or larger phase shift occurs between the oscillations due to the immediate (proportional) or time-delayed (integrating) control response. The phase shift is preferably determined when determining the oscillation characteristics (i.e. period duration and/or frequency and amplitude). The time stamps of the local maxima and/or minima of the actual and setpoint values can be compared with each other for this purpose. If they differ, an average of these differences could be assumed as the phase shift, for example.

If the first query determines that the amplitude X of the oscillation of the actual value x is not greater than the amplitude W of the oscillation of the setpoint value w, it is then checked whether the opposite is the case. If so, it is also checked in this case whether the period duration Tₓ of the oscillation of the actual value x of the valve position is significantly greater than a characteristic period duration T_{c} assigned to the control valve. Alternatively, the corresponding value T_{w} of the oscillation of the setpoint value can of course be used here instead of Tₓ—the period durations of these oscillations should be identical anyway. If this condition is met, i.e. the valve oscillates significantly slower than its maximum possible speed, it is assumed in this case that the oscillations are caused by the higher-level process control (case 4c).

If, on the other hand, it is first determined that X is not greater than W, and it is then found that W is not greater than X, or it is determined that—although W is greater than X—the oscillation is fast, no statement about the cause of the oscillation is possible with the available means (case 4e).

The characteristic period duration T_{c} of the control valve can be determined for these considerations as follows: From the initialization of the control valve during commissioning, the times for a venting and pressurizing process of the valve are known. From this, the travel speed of the valve member can be determined for both directions. This value is averaged and used as the reaction speed vₘₐₓ. The characteristic period duration can now be estimated, wherein, for example, a triangular or a sinusoidal oscillation can be used as a basis. For a triangular oscillation, the period for an amplitude X results in T_{c}=4* X/vₘₐₓ. For a sinusoidal oscillation x(t)=X*sin (ωt), vₘₐₓ=X*ω and ω=2π/T_{c}, thus T_{c}=2π* X/vₘₐₓ.

FIG. 9 shows an overview of an embodiment of the entire method. The starting point can, for example, be activation by a user, e.g. by actuating a switch or requesting a diagnosis or similar. Only the actual value x and setpoint value w of the position control of the control valve are required as measurement data. It is therefore particularly advantageous to carry out the procedure on the positioner of the control valve, provided that it has the necessary computing power, e.g. by means of a digital signal processor. However, further data, e.g. from sensors and/or the process controller, is required for some optional, additionally distinguishable sub-cases.

The measurement signals of actual value x and setpoint value w are preferably first examined for noise, wherein known noise detection methods are used, depending on what kind of noise is to be expected in the process plant in question. If the signals are too noisy, the rest of the method cannot be performed in a meaningful way, as the oscillation detection would most likely provide incorrect or unreliable results, which is why the method ends with a corresponding message 910. This indicates the high level of noise and suspected maintenance requirement for the plant, without specifically limiting this, as the cause of the noise is not readily identified.

If the signals are not noisy, an oscillation analysis is carried out in each case, i.e. as described above, it is determined whether a continuous oscillation is present in x and/or w, and if so, the characteristic oscillation variables, i.e. period duration and amplitude, are determined. The results of the oscillation analyses serve as the basis for case differentiation 900. Depending on whether setpoint value w and/or actual value x oscillate or not, the situation is assigned to one of four cases:

Case 1: There are no continuous oscillations. In this case, the method ends with the message 920 that everything is in order.

Case 2: Only the actual value x exhibits a continuous oscillation. Further sub-cases are distinguished here, which may require different reactions. For this purpose, the period duration Tₓ of the oscillation is compared with the characteristic period duration T_{c} of the control valve, as shown in FIG. 8 for case 4 and described above.
Case 2a: Tₓ is not significantly greater than T_{c}. The cause of the continuous oscillation is presumably an incorrect setting of the proportional component of the valve position control. The method ends with a message 930 indicating that maintenance is required on the control valve. In a specific case, this message may of course also contain more precise information, e.g. that the gain parameter kₚ must be checked as it may be too high.
Case 2b: Tₓ is significantly greater than T_{c}. The cause of the continuous oscillation is presumably an incorrect setting of the integrating component of the valve position control. The procedure ends with a message 930 indicating that maintenance is required on the control valve. In this case, the message may also contain additional information.
Case 2c: Vibrations in the plant are superimposed on the valve actuator or the position measurement signal. However, this case can only be detected with optional additional sensors (e.g. an acceleration sensor or structure-borne sound sensor). It occurs if the signal of this sensor has an oscillation with a period or frequency that corresponds to the period or frequency of the oscillation of the actual value x of the valve control. This should preferably be checked before distinguishing between cases 2a and 2b. If this case occurs, the method ends with a message 940 that maintenance is required on the plant and that the cause of the oscillation is to be sought outside the control valve.
Case 2d: A pulsating fluid flow, for example, transmits vibrations to the valve member, which in turn transmits these vibrations to the position measurement signal via the valve actuator. In order to recognize this, however, the actual value p of the process would also have to be available and examined for oscillations, which is not possible in every embodiment. This is the case if the actual value p of the process and the actual valve position value x oscillate with approximately the same period duration or frequency, but the valve position setpoint value w does not. This should also preferably be checked before differentiating between cases 2a and 2b. If this case occurs, the method ends with a message 940 that maintenance is required on the system and that the cause of the oscillation is to be sought outside the control valve.
Case 2e: This includes all other situations in which only the actual value of the position of the control valve has a continuous oscillation, but which cannot be assigned to one of the other cases 2a-2d. For example, if, in addition to the actual value x, both the process setpoint value p and the signal from an acceleration sensor have oscillations of similar period duration. This case does not have to be realized in every embodiment—in the particularly preferred embodiment without additional sensors and without knowledge of the actual value p of the process, a distinction is only made between the sub-cases 2a and 2b, which provides a clear result in every case if the tolerances are chosen sensibly. If this case occurs, the method ends with an unspecific message 910 that maintenance is required.

Case 3: Only the setpoint value w exhibits a continuous oscillation. Further sub-cases are distinguished here, which may require different reactions.
Case 3a: If the positioner has diagnostic functions for the control valve, these are executed, as the fact that the actual value x does not follow the continuous oscillation of the setpoint value w could be due to a defect in the control valve (e.g. no compressed air supply to the actuator, mechanical jamming, defect of I/P converter, etc.). The method ends with the message 930 that the control valve requires maintenance.
Case 3b: If the setpoint signal w has an amplitude that is too small, the position control of the valve generates a control signal that is too small, which is not sufficient to cause the valve actuator to overcome the hysteresis of the control valve, preferably including a hysteresis of the—typically pneumatic—actuator, the I/P converter, the control and/or the valve member of the control valve, as well as the mechanical friction on the valve. As a result, the valve member does not move. This is preferably checked first, i.e. before case 3a is considered. In this case, the method ends with a message 940 that maintenance is required on the plant and that the cause of the vibration is to be sought outside the control valve. This message can also contain the information that the strength of the setpoint signal w to the control valve must be checked.
Case 3c: This includes all other situations in which only the setpoint value w of the position of the control valve exhibits a continuous oscillation, but which cannot be assigned to case 3a or 3b, e.g. if the amplitude of the oscillation of w is sufficiently large, but the check of the control valve (e.g. by means of a partial stroke test) confirms its functionality. In this case, the method ends with an unspecific message 910 that maintenance is required.

Case 4: Both the actual value x and the setpoint value w of the position of the control valve exhibit continuous oscillations. In this case, a more detailed investigation is required, which can be carried out as shown in FIG. 8 and described above.
Case 4a: In this case, the gain parameter kₚ of the P component of the position control of the control valve has been set incorrectly. The method ends with a corresponding message 930 indicating that the control valve requires maintenance.
Case 4b: In this case, there is an incorrect setting of the I component of the position control of the control valve. The method ends with a corresponding message 930 indicating that the control valve requires maintenance.
Case 4c: In this case, it is assumed that the process controller is the cause of the continuous oscillation. The method ends with a corresponding message 940 that maintenance is required on the plant and that the cause of the oscillation is to be found outside the control valve.
Case 4d: In certain operating scenarios, an oscillating process setpoint may be required. In order to recognize this case, however, the process setpoint value r would have to be available and examined for oscillations, which is not possible in every embodiment. This is the case if the process setpoint value r, the valve position setpoint value w and the actual value x oscillate with approximately the same period duration or frequency. The verification of this case is not shown in FIG. 8 and should precede the other tests shown there. If this case occurs, the method ends with a message 920 that everything is in order.
Case 4e: This includes all other situations in which only both the actual value and the setpoint value of the position of the control valve exhibit a continuous oscillation, but which cannot be assigned to one of the other cases 4a-4d. In this case, the method ends with an unspecific message 910 indicating that maintenance is required.

In some of the cases mentioned, provision may also be made for automatic remedial action to be taken as part of the present method. This applies in particular to cases 2a, 2b, 4a and 4b. If it is detected that the gain parameter kₚ of the proportional component of the position control of the control valve is too high, it could be reduced automatically, wherein it is observed whether the continuous oscillation subsides. The same is conceivable for a reduction of the gain parameter kᵢ and/or an increase in the dead band of the integrating component of the position control. Position control parameters could also be adjusted in case 4c in order to stabilize the process. For example, the gain parameter kₚ of the proportional part of the control could be reduced, or a differential part of the control could—if present—be amplified. As the cause of the oscillation is located outside the control valve, it is still preferable to carry out maintenance on the plant in this case.

The method described enables statements to be made as to whether the continuous oscillations that occur are caused by the control valve or other devices or components of the process engineering plant. This is already very important for rectification or compensation, regardless of an even more precise localization of the origin of the oscillations. It is conceivable that a user is only informed of the type of case identified in accordance with or similar to FIG. 9, or that additional diagnostic steps and/or additional devices or sensors are activated and/or added depending on the type of case, in order to further narrow down the origin of the continuous oscillations if necessary.

### Glossary

### Plant

A plant is a planned combination of technical components. The components may include machines, devices, apparatuses, storage units, lines or transport routes and/or control or regulating elements. They may be connected, interconnected or interlinked in terms of function, control and/or safety. Plants are operated in many different fields for a variety of purposes. These include, for example, process plants, which in many are associated with chemical industry. The term “plants” also includes refineries, district heating systems, geothermal or solar thermal plants, plants for food production, fresh water supply or wastewater disposal, biogas plants, etc.

### Cut-Off Frequency of a Low-Pass Filter

The cut-off frequency of a low-pass filter is typically defined as the frequency at which the output signal A is attenuated by 3 dB compared to the sinusoidal input signal E. This corresponds to A=0.707*E.

### Control Circuit, Control Loop

A control circuit (or control loop) has a controller, a controlled system and a feedback loop. The controlled system acts on a controlled variable, for which a setpoint value w is specified. The actual value of the controlled variable x is measured. From the actual value x and the setpoint value w, the controller determines a manipulated variable y in accordance with the desired dynamics of the control loop, which acts on the controlled variable via the controlled system with the aim of bringing the actual value x closer to the setpoint value w.

Control with Integrating Component

Integrating controllers (also abbreviated to I-controllers) are used to fully compensate for control deviations at every operating point. The control difference or control deviation e is understood to be the difference between the setpoint value w and the actual value x: e=w−x. As long as the control deviation is not equal to zero, the amount of the manipulated variable y changes. Only when the reference and controlled variable, i.e. setpoint value w and actual value x, are equal, but at the latest when the manipulated variable reaches its system-dependent limit value (e.g. maximum voltage), is the control system settled. The mathematical formulation of this integral behavior is: The value of the manipulated variable y is proportional to the time integral of the control deviation e:

y=kᵢ∫e dt

The gain parameter kᵢ is usually defined as the reciprocal of the integration time. The integrating part of a controller is often preceded by a dead zone, e.g. in the form of a characteristic curve.

Control with Proportional Component

With a proportional controller (also abbreviated to P-controller), the actuating variable y is always proportional to the control difference e (difference between setpoint and actual value). This means that a P-controller reacts to a control difference without delay and generates a manipulated variable y if such a deviation is present. The amplitude of the manipulated variable depends on the control difference e and the amount of the proportional coefficient kₚ, which is also referred to as the gain:

y=kₚ*e

A controller compensates for the effect of disturbance variables by generating an opposing control variable. However, a P-controller can only generate this manipulated variable if there is a control deviation. Permanent disturbances can therefore never be completely compensated for with a P-controller; a permanent control deviation always remains. A large kₚ leads to smaller control deviations due to a stronger control intervention. However, kₚ values that are too high increase the tendency of the control loop to oscillate.

### Control Valve

Control valves, also known as process valves, are used to throttle or regulate fluid flows. For this purpose, a valve member is moved in a flow opening of a valve seat by means of an actuator. This allows the flow opening to be opened or closed, thereby changing the flow rate, right up to the complete opening or closing of the flow opening. Typically, a pneumatic or electric actuator is used for this purpose.

### Positioner

A positioner is the element of a control or regulating valve that actuates the drive of the valve member of the valve to open or close the valve. The positioner includes a control loop to control the position of the valve member depending on a specification, e.g. a signal from a control room. The actuator of the valve element—in many cases an electric or fluidic actuator, wherein the latter may be operated either hydraulically or with compressed air—is part of the control loop and therefore unambiguously assigned to the positioner, even if the actuator is located outside the actual positioner.

### REFERENCE SYMBOLS

100 outer control loop
110 process control
120 inner control loop
130 process
210 valve positioner
230 control valve
240 control valve actuator
900 case differentiation
910 maintenance requirement (non-specific)
920 no action required
930 maintenance requirement for control valve
940 maintenance requirement for process control
p actual value of process control
r setpoint value of process control
w setpoint value of valve position control
x actual value of valve position control
y control variable of valve position control
W amplitude of continuous oscillation of w
x amplitude of continuous oscillation of x
Tₓ period duration of oscillation of x
T_{c} characteristic period duration associated with control valve
vₘₐₓ maximum travel speed of valve member

### CITED LITERATURE

### Patent documents

US 2007/0150079 A1

US 2016/0239015 A1

1. Method for identifying the cause of at least one oscillation in a process plant which comprises at least one inner control loop of a control valve and at least one outer control loop, having the following steps:
the setpoint value and the actual value of the inner control loop of the control valve are determined over time;
the setpoint value determined over time and the actual value determined over time are each checked to see whether they exhibit an oscillation;
if at least one oscillation is detected, its amplitude and/or period duration are determined;
if an oscillation is detected only in the actual value or only in the setpoint value, the period duration and/or the amplitude of this oscillation is compared with a predetermined characteristic variable of the control valve;
if an oscillation is detected both in the actual value and in the setpoint value, a phase shift of the two oscillations relative to each other is determined and/or the respective amplitudes are compared with each other and/or at least one of the period durations is compared with a predetermined characteristic variable of the control valve; and
a possible cause of the at least one oscillation is identified from the comparisons made and/or the phase shift.

2. The method according to claim 1, wherein the identified possible cause of the at least one oscillation is assigned to the inner control loop or the outer control loop.

3. The method according to claim 1, wherein in addition to the setpoint value and the actual value of the control circuit of the control valve, only further variables detectable at the control valve are measured and/or used to identify the cause of the at least one oscillation.

4. The method according to claim 1, wherein:
it is determined whether the setpoint value and the actual value of the control loop of the control valve exhibit noise; and
that further steps are only performed if the noise is below a predetermined threshold.

5. The method according to claim 1,
wherein the additional step that the identified possible cause of the at least one oscillation is automatically eliminated by adjusting parameters in the valve position control.

6. The method according to claim 1,
wherein, in order to check whether the setpoint value and/or the actual value exhibit an oscillation, local extreme values of the setpoint value and/or the actual value determined over time are counted and/or evaluated during a predetermined time interval.

7. The method according to claim 1,
wherein a diagnosis and/or maintenance of the control valve is requested if an oscillation is detected only in the setpoint value.

8. The method according to claim 1, wherein:
a characteristic period duration or frequency of the control valve serves as a predetermined characteristic variable; and
a setting of the control of the control valve that is unfavorable for operation of the plant is identified as possible cause of the at least one oscillation if an oscillation is detected only in the actual value and/or if the amplitude of the oscillation of the actual value is greater than the amplitude of the oscillation of the setpoint value and/or if the period duration or frequency of the at least one oscillation corresponds to the characteristic period duration or frequency of the control valve.

9. The method according to claim 8,
wherein the control of the control valve has a proportional component and/or an integrating component, wherein:
a parameter of the proportional component of the control of the control valve which is unfavourable for the operation of the control valve is identified as a possible cause of the at least one oscillation if the period duration of the oscillation, taking into account a tolerance factor, is shorter than the predetermined characteristic period duration and/or the frequency of the oscillation, taking into account a tolerance factor, is greater than the predetermined characteristic frequency and/or the phase shift between the oscillations of the actual value and the setpoint value is below a predetermined threshold; and
a parameter of the integrating component of the control of the control valve which is unfavorable for the operation of the control valve is identified as a possible cause of the at least one oscillation if the period duration of the oscillation, taking into account a tolerance factor, is greater than the predetermined characteristic period duration and/or the frequency of the oscillation, taking into account a tolerance factor, is less than the predetermined characteristic frequency and/or the phase shift between the oscillations of the actual value and the setpoint value is above the predetermined threshold.

10. The method according to claim 1, wherein:
a characteristic period duration or frequency of the control valveserves as predetermined characteristic variable; and
a problem with the control of the process plant is identified as a possible cause of the oscillation if an oscillation is detected only in the setpoint value and/or if the amplitude of the oscillation of the setpoint value is greater than the amplitude of the oscillation of the actual value and/or if the period duration of the oscillation is greater than the characteristic period duration of the control valve or if the frequency of the oscillation is less than the characteristic frequency of the control valve.

11. The method according to claim 1, wherein:
a width of a hysteresis of the control valve, in particular of the actuator, the control, and/or the valve member of the control valve, serves as predetermined characteristic variable; and
if an oscillation is detected only in the setpoint value, the amplitude of the oscillation is compared with the predetermined characteristic variable;
wherein a diagnosis and/or maintenance of the control valve is only requested if the amplitude of the oscillation exceeds the width of the combined hysteresis of the control valve.

12. The method according to claim 1, wherein:
an acceleration and/or structure-borne sound sensor is provided;
wherein signals from the acceleration and/or structure-borne sound sensor are checked for oscillations;
wherein, if an oscillation is detected, the period and/or frequency thereof is determined; and
if an oscillation is detected in the actual value and in a signal of the acceleration and/or structure-borne sound sensor, but not in the setpoint value, the period durations and/or frequencies of these oscillations are compared with each other;
wherein a vibration in the plant is identified as a possible cause of the at least one oscillation if the period durations and/or frequencies of these oscillations in the actual value and in a signal of the acceleration and/or structure-borne sound sensor are identical within a predetermined tolerance.

13. The method according to claim 1, wherein:
an actual value of the process is provided;
wherein the actual value of the process is checked to see whether it exhibits an oscillation;
wherein, if an oscillation is detected, its period duration and/or frequency is determined; and
if an oscillation is detected in the actual value and in the actual value of the process, but not in the setpoint value, the period durations and/or frequencies of these oscillations are compared with each other;
wherein a pulsating fluid flow in the plant is identified as a possible cause of the at least one oscillation if the period durations and/or frequencies of these oscillations of the actual value and of the actual value of the process are identical within a predetermined tolerance.

14. The method according to claim 1, wherein:
a setpoint value of the process is provided;
wherein the setpoint value of the process is checked to see whether it exhibits an oscillation;
wherein, if an oscillation is detected, its period duration and/or frequency is determined; and
if an oscillation is detected in the actual value, in the setpoint value and in the setpoint value of the process, the period durations and/or frequencies of these oscillations are compared with one another;
wherein the at least one oscillation is identified as desired if the period durations and/or frequencies of these oscillations of the actual value, of the setpoint value and of the setpoint value of the process are identical within a predetermined tolerance.

15. A positioner for a control valve, wherein the positioner comprises a computing unit and means suitable and configured for performing the steps of the method according to claim 1.

16. A diagnostic box for use with a control valve, the diagnostic box comprising a computing unit with means suitable and configured for performing the steps according to claim 1.

17. A control valve having a positioner according to claim 15.

18. A non-transitory computer-readable medium on which computer instructions are stored which cause a positioner to perform the method steps of claim 1.
